(19) United States
(12) Patent Application Publication
(10) Pub. No.: US 2005/0076033 A1
(43) Pub. Date: Apr. 7, 2005

(54) Method and system distribute search queries over a network

(76) Inventor: Chris Foo, Costa Mesa, CA (US)

Correspondence Address: Chris Foo, P.O. Box 28151, Santa Ana, CA, 92799, US

(21) Appl. No.: 10/674,546

(22) Filed: Oct. 1, 2003

(51) Int. Cl. G06F 17/30

(52) U.S. Cl. 707/10

(57) ABSTRACT

This method and system is used to distribute on demand queries to computers connected via network. This system was developed to resolve the burden of centralized search engine as well as to improve the accuracy of search results. Upon successful processed search queries by decentralized remote systems, the search results will be forwarded directly to requester. The smart filtering routines residing on requester's system will further filter the search results with search history or preferences stored in the system. This method would also dynamically extend the search index to the content of files as well as performing other tasks such as program execution simultaneously.

### DETAILED DESCRIPTION

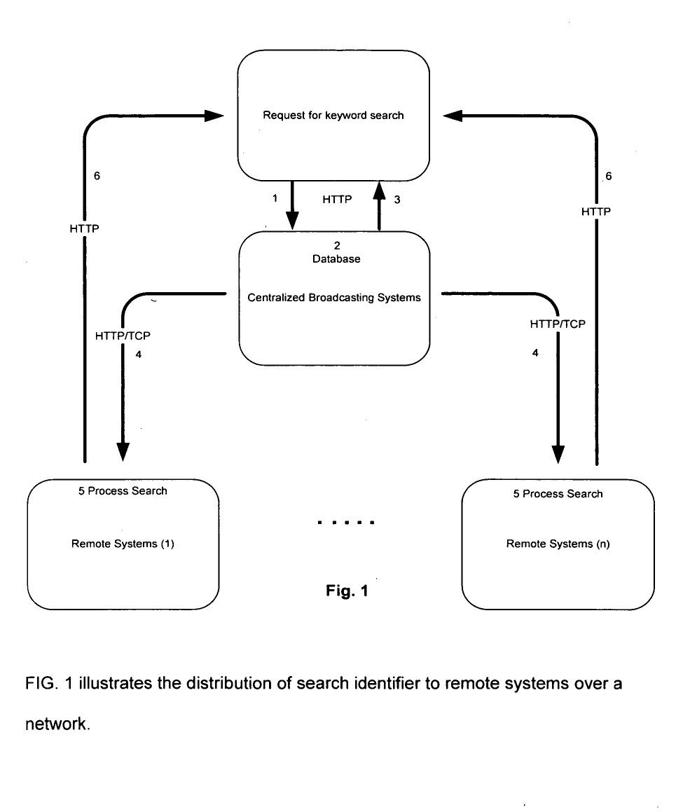

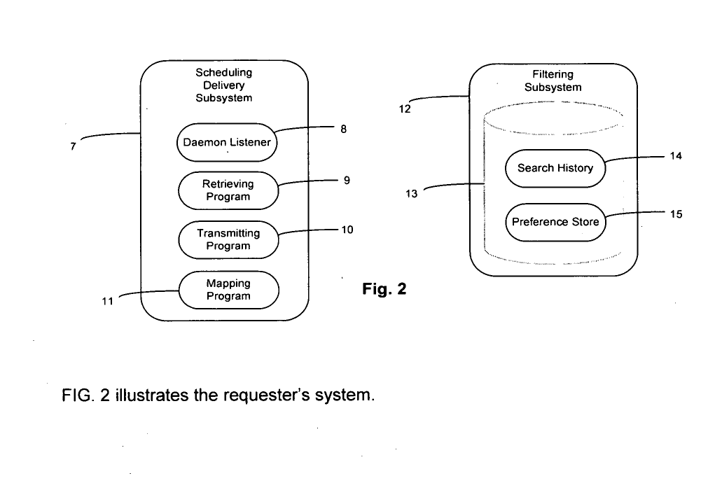

FIG. 1 illustrates the distribution of search identifier to remote systems over a network. 1 shows user request keyword search either from a web browser or a proprietary desktop application. When the Centralized Broadcasting System's receiver program 20 received the search identifier consists of information such as requester's IP Address, Session ID, search keywords and categories via HTTP or other network communication protocol. The matching program 26 resided in Centralized Broadcasting System will parse the search identifier and conduct an initial search against its database 23. If the search keyword is ambiguous and required more information, the transmitting program 19 will sent a string of generic tag to requester's system requesting more information. An example of ambiguous keyword is “Foo”, where the matching program 26 will require additional information to improve the search accuracy. Thus, a tag such as <history>Foo</history> will be transmitted back to requester's system requesting more information. When the retrieving program 9 received the tag, it will be forwarded to the mapping program 11 to translate the tag and querying the search history 14 looking for any data that consists of keyword “Foo”. If the search does return a value for example, “music”, it will be translated in a return tag <searh found>music</search found> ready to be transmitted back to the Centralized Broadcasting Systems. Otherwise, if search return a null value, the return tag will be empty.

Upon receiving the additional information, the Centralized Broadcasting System's matching program 26 will conduct the search against its database 23. The search keyword will be matched against any index 24 stored in the database and the description 25 corresponded to the index will be cached into a temporary memory ready to be transmitted back to the requester's system. Nevertheless, the search keyword as well as information in the search identifier will be temporary stored in the Centralized Broadcasting System's Request Subsystem 27 ready to be queried by all remote systems.

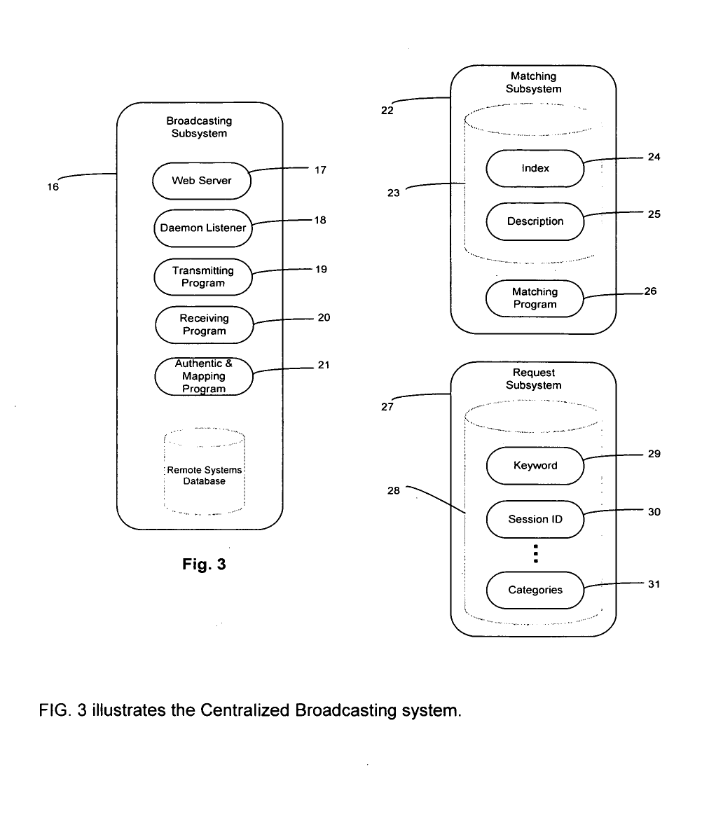

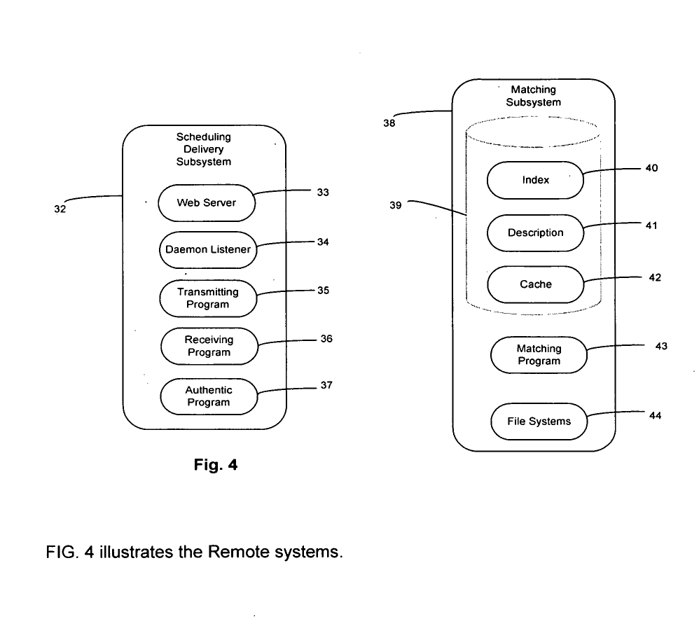

FIG. 4 illustrates the Remote System where the Daemon Listener program 34 is scheduled to connect to Centralized Broadcasting Systems querying for any search keywords. The Remote System can be a web hosting companies or an individual private system with required program installed. The scheduling of the remote Daemon Listener is independent of each others which mean, some remote daemon could scheduled to connect every 5 seconds and some could be every 10 minutes.

The authentic program 37 resided in the Remote Systems will exchange the private and public encrypted keys with Centralized Broadcasting system's authentic program 21 verifying every transactions. Once the Remote Systems received the all search identifiers from the Centralized Broadcasting Systems, the matching Program 43 will conduct a details match against its database. If any record is found, the description will be cached in the temporary memory ready to be transmitted to the requester's systems directly as batch.

In additional to searching for keywords, requester also able to combine the keyword and filename search. For example, the requester would be able to search for topic regarding “Foo” simultaneously executing a program “runReports.exe” residing on one of the remote systems. Of cause the basic “runReports.exe” such as the location of the program file should already be setup in the Remote System's database. After the matching process is completed, the search result stored in the temporary memory will then be transmitted to requester's system by the remote transmitting program 35.

The requester's filtering Subsystem 12 will filter all incoming data from the Remote Systems based on the Preference 15 stored. One such example of the information stored in the Preference is maximum allowed number of records return, or to block certain remote IP Address etc.

### BACKGROUND

Most search engines operate under the assumption that keywords will be entered and a result document will be returned for viewing. However, this assumption is not true where a user might want to search for a link or documents based on the keyword entered simultaneously would also like to perform other tasks simultaneously such as retrieve a file or execute a program resided in the remote system which related to the search keyword.

In addition, the existing search engines are centralized search systems where all the search information stored in a centralized system. This created two problems:
1. A webmaster might have to wait for months from the search hosting companies before the web site is reviewed and posted in the search engines database.
2. The search engine database is growing exponentially with more data being added to the database.

Therefore, a needed for methods and apparatus to resolve the overwhelm data stored in a centralized system as well as creating a dynamic and accurate search systems.

### SUMMARY

Methods and apparatus consistent with the present invention, as embodied and broadly described herein, provide a decentralized search systems in response to the over burden centralized systems. In addition, this invention also allowing other tasks to be performed simultaneously while searching is being performing. Consistent with the invention, a personalized filtering system in the user's local system allowing a more accurate search result being display to the user.

1. The method of claim 1, wherein the search identifier comprises one of dynamic and binary content. A computer-implemented method for decentralizing and distributing over a network a search queries and performing other on demand tasks simultaneously. The method comprising: process search identifier; updating search identifier to a centralized broadcasting systems; receive process identifier from a remote systems; retrieving search identifier by remote systems; transmit search result from remote systems to requester; filtering search result by requester; reset search identifier in the centralized broadcasting systems.

2. The method of claim 1, wherein binary content further comprises remote requester's information such as IP Address, Session ID, search keywords and categories.

3. The method of claim 2, wherein requester is the person making the search request.

4. The method of claim 1, wherein centralized broadcasting systems further comprises of a database system and a matching software program.

5. The method of claim 4, wherein database system is used to temporary store the search identifier.

6. The method of claim 4, wherein the matching software program is used to match refined keyword search or category against data stored in the centralized broadcasting systems if such information exists.

7. The method of claim 1, wherein process search identifier further comprises the steps of: retrieving search history or preferences stored in requester's system; updating tables and transmitting search result to requester if matching existed in the centralized broadcasting systems.

8. The method of claim 7, wherein retrieving search history or preferences stored in requester's system comprises transmitting encrypted command to requester's system in the background and retrieves the information to refine the search.

9. The method of claim 7, wherein update tables comprises insert the search identifier as a temporary record into table as search index allowing remote systems to retrieve for processing.

10. The method of claim 9, wherein remote systems are computers connected via network with a remote local database and daemon software installed.

11. The method of claim 10, wherein daemon software is a computer program connect to the centralized broadcasting systems at a predetermined period and interacts with them.

12. The method of claim 10, wherein remote local database is used to store all files information resided on the remote systems.

13. The method of claim 12, wherein file information comprises records such as of keywords, descriptions and the files location.

14. The method of claim 1, wherein process identifier comprises remote system's encrypted security code and remote system's categories if available.

15. The method of claim 1, wherein receive process identifier from a remote systems further comprises steps to validate the integrity of remote systems and process categories matching against the centralized broadcasting's search index database only if the validation is successful.

16. The method of claim 15, wherein validate the integrity of remote systems comprises of routines to decrypt the encoded string and comparing the coded against the centralized broadcasting database.

17. The method of claim 1, wherein retrieving search identifier by remote systems comprises steps to query and retrieve all the search identifiers from the temporary tables.

18. The method of claim 1, wherein transmit search result from remote systems to requester further comprises steps to process retrieved search identifier and generating search result string transmitting back to requester.

19. The method of claim 18, wherein process retrieved search identifier comprises querying the search keyword in the database matching and retrieving key indexes and descriptions based on conditions received from the centralized broadcasting systems.

20. The method of claim 18, wherein generating search result string transmitting back to requester further comprises routines to sort the search result based on the highest match possibilities and transmitting to requesters in binary streams of data.

21. The method of claim 1, wherein filtering search result by requester further comprises filtering routines to filter the incoming search results based upon the user search history or preferences stored in the requester's system.

22. The method of claim 1, wherein reset search identifier in the centralized broadcasting systems comprises of transmitting command from requester's system to delete the requester's search identifier from the temporary database in the centralized broadcasting systems.
